(19) United States
(12) Patent Application Publication
(10) Pub. No.: US 2004/0177912 A1
(43) Pub. Date: Sep. 16, 2004

(54) Corrugating machine with multiple thermal position sensing

(76) Inventor: James Burrows, Plainfield, IL (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/389,418

(22) Filed: Mar. 14, 2003

(51) Int. Cl. B32B 31/00; B65H 19/00

(52) U.S. Cl. 156/64; 156/459; 156/461

(57) ABSTRACT

A machine for producing corrugated board which utilizes a dual thermal sensing system to determine the length of the web is disclosed. The corrugating machine includes a frame through which a web material is adapted to be traversed, an applicator adapted to apply a liquid spot, such as water, to the web, and first and second temperature sensors adapted to detect the liquid spot after the liquid spot is applied.

### FIELD OF THE DISCLOSURE

The present disclosure relates to machines for producing corrugated board, and more specifically, it relates to machines having a mechanism for automatically determining the length of web material in a bridge of the machine.

### BACKGROUND OF THE DISCLOSURE

Conventional corrugating machines produce double-faced corrugated board from two continuous webs of flat paper and a third continuous web of corrugated paper. In one prior art corrugating machine, a web of paper is corrugated by a pair of corrugating rollers and glued to a web of flat paper to produce a single-faced corrugated web, which is supplied to the bridge of the corrugating machine.

Each of the paper webs used to form the single-faced corrugated web is fed from a large roll of paper, which periodically runs out. As one of the paper rolls runs out of paper, a paper web from a new roll is spliced onto the paper web from the old roll via a conventional splicer. To accommodate the splicing of the new roll to the old roll, the portion of the corrugating machine which produces single-faced corrugated board may be slowed somewhat; consequently, the speed at which the single-faced corrugated web is provided to the bridge is variable.

The single-faced corrugated web is removed from the bridge of the corrugating machine and is bonded to a third web of paper to produce double-faced corrugated web, which is then supplied to a conventional cutter which cuts the double-faced corrugated web into desirable sizes.

When one of the paper webs from which the single-faced corrugated board is produced is spliced by one of the splicers, the web portion in which the splice is made is twice as thick as usual due to overlap of the original paper web with the new paper web. This extra-thick web portion is undesirable and is automatically cut out by the cutter (which may be the main cutter or an auxiliary cutter) after the double-faced corrugated web is produced.

The prior art corrugating machine described above may incorporate a method of automatically cutting out the extra-thick web portion based upon a procedure which periodically determines the length of the web that is in the bridge portion of the corrugating machine. Since the single-faced corrugated web is supplied to the bridge at a variable rate and removed from the bridge at a variable rate, the length of the web in the bridge at any time is variable.

In the prior art method, the length of the web in the bridge is determined, and then the total length of the web from one of the splicers to the cutter is determined based thereon (the length of the web from one of the splicers to the bridge is a known constant, and the length of the web from the bridge to the cutter is a known constant). As soon as a splice is made, the corrugating machine starts measuring the web length from the splicer to the cutter. When the measured web length is slightly less than the total web length, the cutter makes a first cut, waits for a period of time or a distance, and then makes a second cut, so that the extra-thick spliced portion of the web is cut out from the web.

In a prior art method of determining the length of the web in the bridge, an ink mark is sprayed onto a portion of the single-faced corrugated web just prior to its entry into the bridge. An ink mark detector is positioned at the exit of the bridge, and a measuring wheel that abuts against the single-faced corrugated web generates a plurality of counts in direct proportion to the travel of the single-faced corrugated web. The length of the single-faced web in the bridge is determined based on the number of pulses that are generated by the measuring wheel between the time the ink mark is sprayed and the time the ink mark is later detected by the detector. This manner of determining the length of the single-faced corrugated web in the bridge allows the splice to be cut out, without the need to cut out usable, adjacent portions of the web. While effective, such a method is relatively expensive, can be messy in use, leaves an undesirable ink stain on the corrugated board, and can cause maintenance problems.

Accordingly, it is also known to use a thermal position sensor system. For example, U.S. Pat. No. 5,676,790, assigned to the present assignee, discloses the use of a water mark instead of an ink spot to determine the length of the web in the bridge. A temperature detector is used to detect the passing water mark. The water is generally cooler than the web itself, and when the temperature detector reads a lower temperature than a preset level, the water mark is detected. Where water or another colorless liquid is used, a corrugating machine in accordance with such a disclosure is advantageous in that the water spots evaporate completely, leaving no objectionable mark on the paper web. However, false signals can be generated under this system as the temperature of the paper itself can vary along its length due to the festooning process or other variables affecting the line. The temperature also may be too hot to register under the preset level.

Other methods of determining the length of the web in the bridge, such as the use of metal foil pieces which are adhesively applied to the web, are relatively expensive and have other disadvantages including maintenance problems.

### SUMMARY OF THE DISCLOSURE

A machine is disclosed which is designed to detect a liquid spot on a web of material. In the first example, a frame is provided through which a web of material traverses. An applicator is positioned proximate the web, adapted to apply a liquid spot to the web material. Two temperature sensors are placed downstream of the applicator and proximate the web. By detecting the temperature of the web, they are able to detect the presence of the liquid spot.

In a second example, a method to detect the length of a web is disclosed. The moving web is sprayed with a spray nozzle before the web enters a bridge. The length of the web is continuously monitored as it traverses its path. The presence of a liquid spot is detected by comparing two temperatures of the web read by two temperature detectors. When the difference between the two temperatures is greater than a preset level, the liquid spot is detected.

These and other aspects and features of the present disclosure will be apparent to those of ordinary skill in the art upon reading the following when taken in conjunction with the accompanying drawings.

### BRIEF DESCRIPTION OF THE DRAWINGS

FIG. 1A is a schematic side view of a first portion of a corrugating machine, constructed in accordance with the teachings of the disclosure;

FIG. 1B is a schematic side view of a second portion of a corrugating machine, constructed in accordance with the teachings of the disclosure;

FIG. 2 is a flowchart of the method of determining the length of the web in the bridge of the corrugating machine; and

FIG. 3 is a flowchart of the method of cutting out a portion of a web which is undesirably thick due to its being spliced.

FIG. 4 is a schematic plan view of the web, liquid spot and first and second temperature sensors.

### DETAILED DESCRIPTION

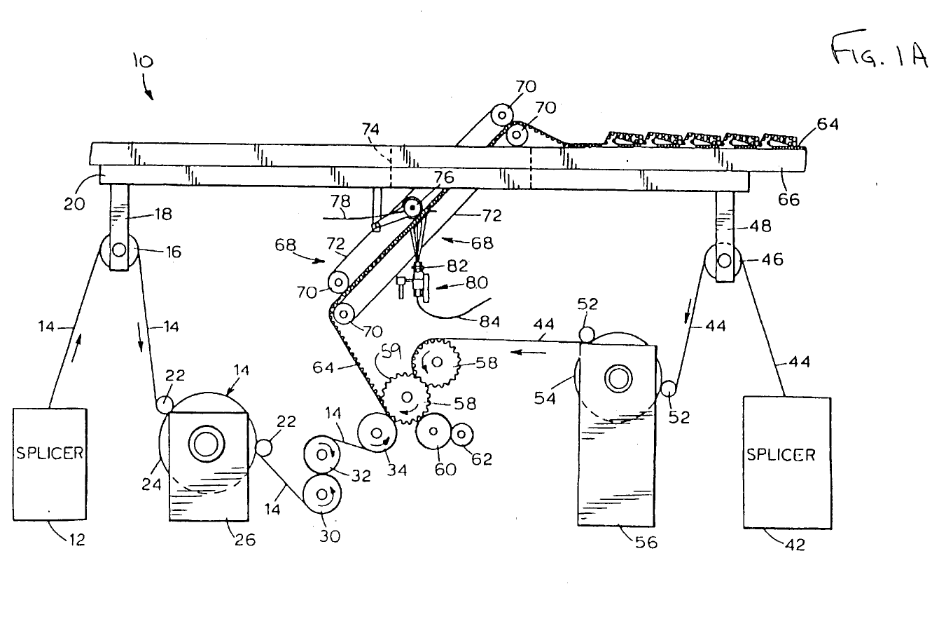

Referring now to the drawings and with specific reference to FIG. 1A, a first portion of a corrugating machine, constructed in accordance with the teachings of the disclosure is generally referred to by reference numeral 10. The corrugating machine 10 includes a conventional splicer 12 which supplies a paper web 14 from a paper roll (not shown) to a cylindrical idler roller 16 rotatably supported by a support member 18 attached to a frame portion 20. The paper web 14 passes underneath a pair of cylindrical rollers 22 and over a top portion of a large pre-heating roller 24 supported by a frame portion 26. The web 14 passes underneath a lower roller 30, between the roller 30 and an upper roller 32, and to the underside of a roller 34.

The corrugating machine 10 includes a second conventional splicer 42 which supplies a paper web 44 from a paper roll (not shown) to a cylindrical idler roller 46 rotatably supported by a support member 48 attached to the frame portion 20. The paper web 44 passes underneath a pair of cylindrical rollers 52 and over a top portion of a large pre-conditioner roller 54 supported by a frame portion 56. The web 44 passes between a pair of corrugating rollers 58, each of which has a fluted corrugating surface 59, which corrugate the web 44. An adhesive is applied to the top portions of the corrugated web 44 via a conventional apparatus in the form of a pair of adhesive applicator rollers 60, 62.

The paper web 14 is adhesively bonded to the corrugated web 44 when the webs 14, 44 come into contact together at the junction of the rollers 34, 58 so that a single-faced corrugated web 64 is formed. The web 64 is transported to a bridge 66 via a conveyor mechanism composed of a pair of conveyors 68, each of which has a pair of rollers 70 which support a respective conveyor belt 72, with the web 64 passing between the conveyor belts 72 through an aperture 74 formed in the bridge 66. The conveyor mechanism supplies the web 64 to the bridge 66 at a rate which may be about seven times greater than the speed at which the web 64 is conveyed along the bridge 66 by a number of bridge conveyor belts (not shown). When supplied to the bridge 66, a portion of the web 64 may automatically fold over itself a number of times as shown in FIG. 1A.

As it passes between the conveyor belts 72, the single-faced corrugated web 64 makes non-slip contact with a measuring wheel 76 that rolls along the top surface of the web 64 and generates a number of electrical pulses on a line 78, each pulse corresponding to a given length of the web 64. For example, the measuring wheel 76 may generate 10 pulses for each foot or meter of the web 64 that passes underneath it.

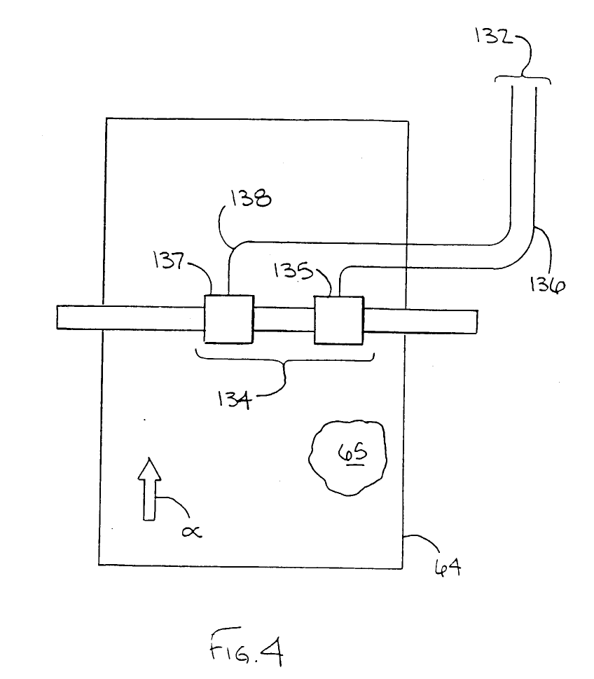

The single-faced corrugated web 64 may be selectively sprayed with liquid at a spot or location on the web 64 via a spraying apparatus 80 with a spray nozzle 82 upon the receipt of an electrical spray signal generated on a line 84. This creates a liquid spot 65 on the web 64 as can best be seen in FIG. 4.

A second portion of the corrugating machine 10 is illustrated in FIG. 1B. Referring to FIG. 1B, the single-faced corrugated web 64 passes from the bridge 66 to a curved web support 86 and then beneath a pair of rollers 88 and over the top portion of a large pre-heater roller 90, from which it passes to a small roller 92 disposed adjacent a larger roller 93 and to a bonding machine 94. The bonding machine 94 is conventional and may include a pair of adhesive applicator rollers like the rollers 60, 62 which apply adhesive to the corrugated portions of the single-faced web 64 and a pair of rollers through which the web 64 passes along with a third web after adhesive is applied.

The length of the web 64 which leaves the bridge 66 is measured by a second measuring wheel 96 which rolls along the top surface of the web 64 and generates a number of electrical pulses on a line 98, each pulse corresponding to a given length of the web 64. The measuring wheel 96 could be provided at different locations within the corrugating machine 10. The controller 130 is connected to receive the electrical pulses generated on the line 98 by the measuring wheel 96.

A third splicer 102 supplies a third paper web 104 from a paper roll (not shown) to a cylindrical roller 106 rotatably supported by a support member 108 attached to a frame portion 110. The paper web 104 passes underneath a pair of cylindrical rollers 112, over a top portion of a large roller 114 supported by a frame portion 116, and to the bonding machine 94 where it is bonded to the single-faced corrugated web 64 to form a double-faced corrugated web 120. The double-faced corrugated web 120 is provided to a cutter 122, which selectively cuts the web 120 into pieces of desired size, in accordance with electrical signals generated on a line 124 connected to a controller 130.

The controller 130 is connected to receive electrical signals transmitted by a temperature relay system 132, generated by a temperature detection system 134. The temperature detection system 134 is disposed directly adjacent the same side of the surface of the web 64 that was previously sprayed with the liquid via the nozzle 82. As can be best seen in FIG. 4, the temperature detection system 134 may be composed of a first temperature detector 135 and a second temperature detector 137. In alternative embodiments, it is to be understood that multiple detectors in excess of two may be employed. The temperature relay system 132 is composed of a first relay line 136 and a second relay line 138. The first temperature detector 135 is disposed directly in the path of travel of the liquid spot 65. It continuously reads the temperature of the web 64, including the temperature of the liquid spot 65. The second temperature detector 137 is disposed laterally from the first temperature detector 135, perpendicular to the direction of travel of the web 64. The second temperature detector is disposed such that it is not in line with the path of the liquid spot 65, and it only reads the temperature of the web 64 that has not been sprayed with liquid.

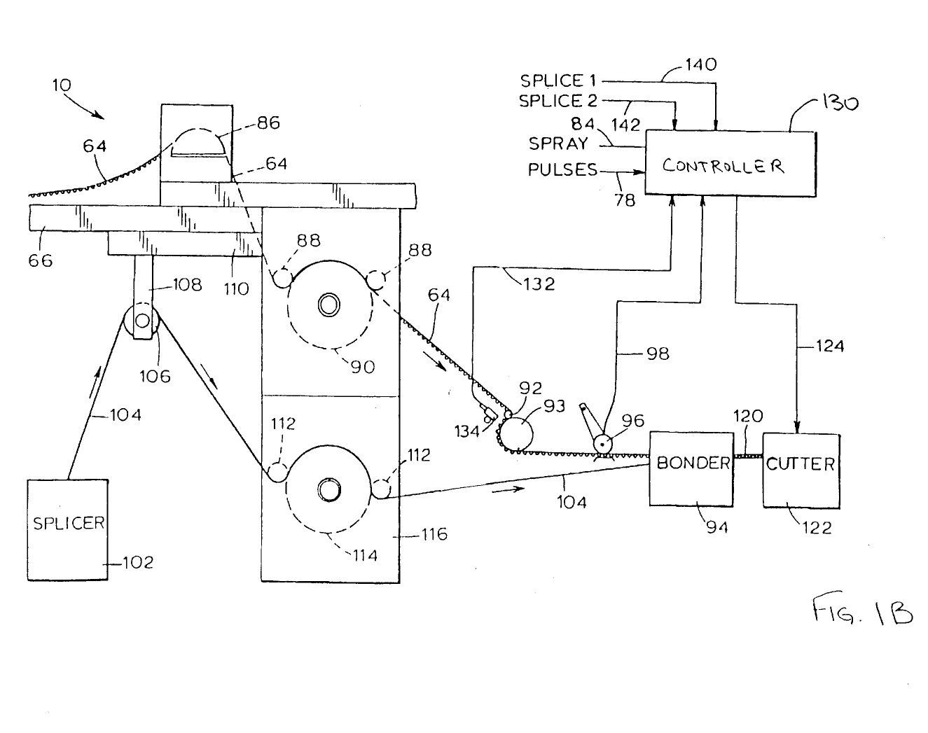

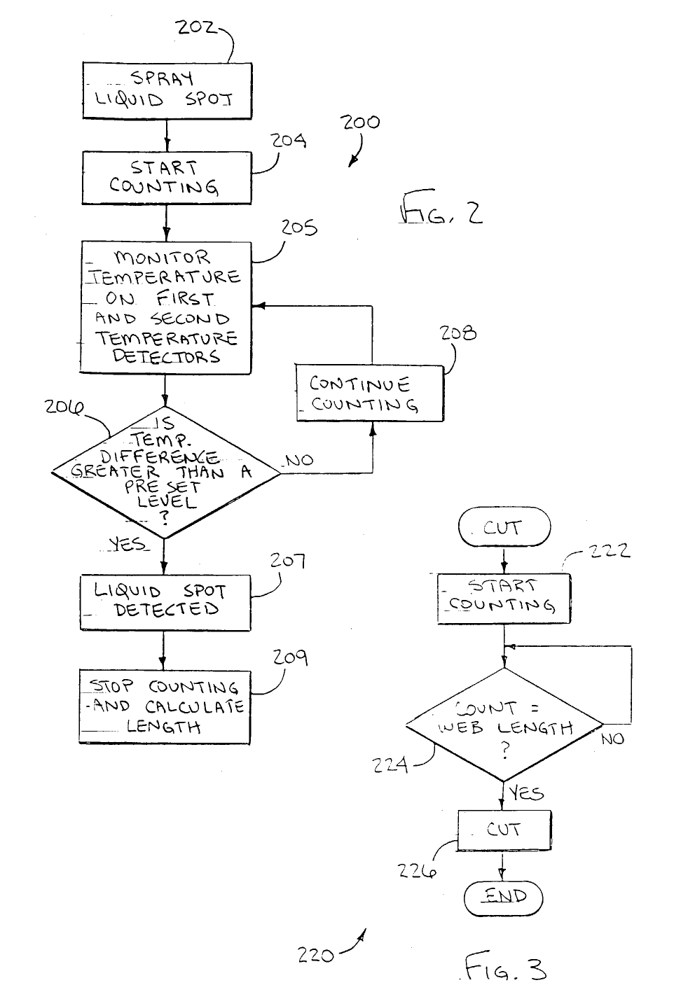

The operation of the corrugating machine 10 is described below in connection with FIGS. 2 and 3, which illustrate a portion of the operation of the controller 130. The controller 130 may be composed of one or more conventional programmable logic controllers or a conventional computer system, such as a personal computer.

FIG. 2 illustrates a procedure 200 that may be periodically performed by the controller 130 to determine the length of the web 64 that is in the bridge 66. This web length may be arbitrarily defined in a number of different ways, such as the length of the web 64 from the measuring wheel 76 (FIG. 1A) to the temperature detector 134 (FIG. 1B), and is not limited to the length of the web 64 that physically lies on top of the bridge 66. The procedure 200 may be performed every five or ten minutes or so, for example, or a predetermined number of times between each expected splice of one of the paper webs 14, 44.

Referring to FIG. 2, the first step in the procedure 200 is step 202, at which liquid is sprayed at a spot or location on the corrugated web 64 via the nozzle 82. This is initiated by sending a SPRAY command from the controller 130 to the spray apparatus 80 via the line 84. As soon as SPRAY command is sent, step 204 is initiated and the controller 130 begins counting the number of pulses that are being generated by the measuring wheel 78. The temperature detectors 135, 137 then begin continuously monitoring the temperature of the web at their respective locations at step 205.

The controller 130 continues to count the number of pulses, while simultaneously determining at step 206 if the difference in temperatures senses by detectors 135,137 is greater than a predetermined threshold as determined. The controller 130 is able to determine when the spot is detected by the detectors 135, 137 by comparing the electrical signal generated by the detector 135, which is representative of the temperature of the web 64 in line with the liquid spot 65, with the electrical signal generated by the detector 137, which is representative of the temperature of the web 64, because the spot at which the liquid was sprayed is generally cooler, due to evaporation of the liquid from the spot, than the remaining portions of the web 64. When the difference between the temperatures sensed by the detectors 135, 137 is greater than a predetermined temperature threshold, the liquid spot 65 is detected. In so doing, the likelihood of a false positive reading, such as those periodically encountered with single temperature sensor systems due to variations in the web temperature, is abated. If the difference is not greater than the preset level, the controller continues counting at step 208, and the temperature detectors continue monitoring the temperature of the web.

Once the liquid spot is detected at step 207, the length of the web 64 in the bridge 66 is determined at step 209 based upon the number of pulses counted by the controller 130 between the spraying of the liquid spot at step 202 and the detection of the liquid spot at step 207. That number of pulses corresponds to the current length of the web 64 from the measuring wheel 78 to the temperature detection system 134.

The length of the web in the bridge 66 periodically calculated via the procedure illustrated in FIG. 2 is used to perform a cutting procedure 220 which controls when the cutter 122 cuts out an extra-thick portion of the double-faced corrugated web 120 which is generated by a splice.

Referring to FIG. 3, when either one of the splicers 12, 42 splices a new web onto the current web, a SPLICE signal is transmitted to the controller 130 via one of a pair of lines 140, 142. As soon as the SPLICE signal is received, the controller 130 starts counting the number of pulses received at step 222 from the measuring wheel 96 via the line 98.

It should be understood that the total length of the web from either of the two splicers 12, 42 to the cutter 122 is known, since the web length from one of the splicers to the bridge 66 is fixed (and corresponds to a fixed number of pulses), since the variable length of the web 64 within the bridge 66 is known (and corresponds with a given number of pulses), and since the length of the web from the bridge 66 to the cutter 122 is fixed (and corresponds to a fixed number of pulses).

At step 224, when the number of pulses being counted at step 222 reaches a predetermined number of pulses corresponding to a length slightly shorter, e.g. four inches, than the total length of the web from one of the splicers 12, 42 to the cutter 122, then at step 226 the controller 130 sends a CUT signal to the cutter 122. In response to the CUT signal, the cutter 122 makes a first cut in the double-faced corrugated web 120, waits a predetermined period of time, e.g. corresponding to eight inches of web travel, and then makes a second cut in the double-faced corrugated web 120 a predetermined distance after the first cut, so that the extra-thick spliced portion is cut out of the web 120.

It should be understood that if the fixed web length between the splicer 12 and the bridge 66 is different than the fixed web length between the splicer 42 and the bridge 66, two different pulse thresholds may be used at step 224, depending upon which of the splicers 12, 42 generated the splice. The cutter 122 also cuts out extra-thick portions of the web 120 caused by splices made by the splicer 102; however, those portions are easily identified since the splicer 102 is located a fixed web length from the cutter 122.

It should also be understood that the procedures illustrated in FIGS. 2 and 3 are only exemplary, and that different procedures could be utilized in the implementation of the invention. A number of conventional components of the corrugating machine 10 illustrated in FIGS. 1A and 1B have been omitted, such as an oven for curing the corrugated board and a stacker for stacking pieces of the corrugated board after it is cut by the cutter 122. Other conventional components could be included in the corrugating machine 10.

It is clear that modifications and alternative embodiments of the disclosure will be apparent to those skilled in the art in view of the foregoing description. In particular, the disclosure could be used to determine the length of any kind web in a machine during processing, not just a corrugated paper web. This could include another kind of paper, fabric, tape, etc. Moreover, the teachings of the disclosure provide a more accurate and reliable temperature sensing system in that false positive readings are reduced through the use of first and second temperature sensors.

This description is to be construed as illustrative only, and is for the purpose of teaching those skilled in the art the best mode of carrying out the invention. The details of the structure and method may be varied substantially without departing from the spirit of the invention, and the exclusive use of all modifications which come within the scope of the appended claims is reserved.

What is claimed is:

1. A machine, comprising:
a frame through which a web of material is adapted to traverse;
an applicator proximate the web, the applicator being adapted to apply a liquid spot to the web; and
first and second temperature sensors proximate the web and adapted to detect the liquid spot.

2. The machine of claim 1, wherein the first temperature sensor is positioned to sense a temperature of the web proximate to the liquid spot, and the second temperature sensor is positioned to sense a temperature of the web distal from the liquid spot.

3. The machine of claim 2, further including a processor, the processor being adaptable to receive first and second temperature signals from the first and second temperature sensors.

4. The machine of claim 3, wherein the processor is adapted to detect the liquid spot where a difference between the first and second temperature sensor signals is greater than a predetermined value.

5. The machine of claim 4, further including a length measuring wheel positioned adjacent the web.

6. The machine of claim 5, further including a bridge, wherein the length of the web in the bridge is determined by reading the length of web material measured by the measuring wheel that has entered the bridge from a time at which the nozzle sprayed the web until the liquid spot is detected.

7. The machine of claim 1, further comprising first and second paper sources.

8. The machine of claim 1, further comprising first and second splicers.

9. The machine of claim 1, further comprising a corrugating roll.

10. The machine of claim 1, wherein the applicator is a spray nozzle.

11. The machine of claim 1, further comprising a web conveyor system.

12. The machine of claim 1, further comprising a cutter.

13. The machine of claim 1, wherein the machine is a corrugating machine.

14. The machine of claim 1, wherein the liquid spot is a water mark.

15. The machine of claim 1, wherein the web of material is paper.

16. An apparatus for producing corrugated paper, comprising:
a first paper source adapted to supply the apparatus with a first paper web;
a second paper source adapted to supply the apparatus with a second paper web;
a first splicer to splice the first paper web at a first splice point;
a second splicer to splice the second paper web at a second splice point;
a pair of corrugating rollers adapted to corrugate the second paper web;
adhesive rollers adapted to adhere the first paper web to the corrugated second paper web, thereby forming a single-faced corrugated web;
a spray nozzle adapted to apply a liquid spot on the single-faced corrugated web, communicating the application of the liquid spot to a controller;
a conveyor system adapted to deliver the single faced web to a bridge where a variable length of the single-faced web may accumulate;
a measuring wheel to continuously measure a length of the passing single-faced web before it is transported to the bridge, communicating the length to the controller a first temperature detector placed downstream of the bridge, in line with the path of travel of the liquid spot, communicating a first temperature output to the controller;
a second temperature detector placed laterally to the first temperature detector, distal from the path of travel of the liquid spot, communicating a second temperature output to the controller; and
the controller monitoring the first and second temperature outputs of the first and second temperature detectors, wherein when a difference in temperature outputs greater than a preset value is detected, the liquid spot is detected.

17. The machine of claim 16, wherein the controller further determines the length of the single-faced web in the bridge based upon the measured length of the web between the time the liquid spot is applied and the time the liquid spot is detected;

18. The machine of claim 16, further comprising a cutter to remove portions of the web that have been spliced at a splice point, the determination of the splice based upon the variable length of the single faced web in the bridge.

19. The apparatus of claim 16, further comprising:
a third paper source to supply the apparatus with a first paper web;
a third splicer to splice the third paper web at a third splice point;
adhesive rollers to adhere the third paper web to the single-faced web to form a double-faced corrugated web.

20. A method to detect the length of a web, comprising:
spraying a liquid spot on a moving web with a spray nozzle before the web enters a bridge, the liquid spot on the moving web traveling along a path;
continuously measuring the length of the web before it enters the bridge;
detecting the presence of the liquid spot in the web by comparing the temperatures read by first and second temperature detectors placed downstream of the bridge, wherein a liquid spot is detected when the difference is greater than a preset level;

21. The method of claim 20, further comprising determining the length of the single-faced web in the bridge by reading the length of web measured by a measuring wheel that has entered the bridge from when the nozzle sprayed the web until the liquidspot is detected.

22. The method of claim 20, wherein the web is a corrugated paper web.

23. The method of claim 21, further comprising:
splicing a first web source at a first splice point with a first splicer;
cutting out the first splice point with a cutter, the cut points being determined based on the length of the web in the bridge.

24. The method of claim 20, further comprising:
locating the first temperature sensor distal from the path of liquid spot;
locating the second temperature sensor proximate to the path of the liquid spot.

25. A machine, comprising:
a frame through which a web of material is adapted to traverse;
an applicator proximate the web, the applicator being adapted to apply a liquid spot to the web;
the liquid spot having a path of travel;
multiple temperature sensors proximate the web and adapted to detect the liquid spot;
one or more of the multiple temperature sensors in line with the path of travel of the liquid spot; and
one or more of the multiple temperature sensors positioned distal from the path of travel of the liquid spot.
